(19) United States
(12) Patent Application Publication
(10) Pub. No.: US 2008/0027207 A1
(43) Pub. Date: Jan. 31, 2008

(54) Non-precipitating alkali/alkaline earth metal and aluminum compositions made with mono-ol ether solvents

(76) Inventor: Jason Christopher Jenkins, Kingsport, TN (US)

Correspondence Address: BRETT L. NELSON;EASTMAN CHEMICAL COMPANY, 100 NORTH EASTMAN ROAD, KINGSPORT, TN, 37660-5075, US

(21) Appl. No.: 11/495,416

(22) Filed: Jul. 28, 2006

(51) Int. Cl. C08G 63/00

(52) U.S. Cl. 528/276

(57) ABSTRACT

A catalyst solution suitable for catalyzing the polycondensation of reactants to make polyester polymers comprising:
(i) M, wherein M is represented by an alkaline earth metal or alkali metal and
(ii) aluminum metal and
(iii) a mono-functional solvent comprising a mono-ol ether of a diol,
   wherein the molar ratio of M:Al ranges from 0.2:1 to 10:1. The catalyst composition is desirably a solution which does not precipitate upon standing over a period of at least two days, or at least one week at room temperature (25° C.-35° C.), even at molar ratios of M:Al approaching 1:1. There is also provided a method for the manufacture of the composition, its feed to and use in the manufacture of a polyester polymer, and polyester polymers obtained by combining certain ingredients or containing the residues of these ingredients in the composition.

### 1. FIELD OF THE INVENTION

The invention pertains to aluminum based compositions useful in the manufacture of polyester polymers, and more specifically to catalysts comprising aluminum and alkaline earth metal or alkali metals which do not precipitate upon standing, even at low alkaline earth metal or alkali:aluminum molar ratios.

### 2. BACKGROUND OF THE INVENTION

Solutions prepared from alkaline earth metal or alkali metals (“M”) and aluminum tend to precipitate over time. This problem is especially noticeable at molar ratios of M:Al approaching 1:1, where precipitation begins to occur at moderate temperatures less than 125° C. This is because aluminum compounds do not easily dissolve in solvents or carriers such as ethylene glycol. The feed of catalyst components to a melt phase polymerization process should stay in solution to provide a more uniform mixing with the reactants or polymer melt, and to enable feeding a consistent and uniform amount of desired catalyst to the melt phase process. A catalyst solution has advantages over catalyst slurries, in that a solution avoids the potential for pumping and circulation problems, avoids transfer line fouling and plugging, and avoids the requirement of vigorous agitation required for slurries in order to prevent insoluble catalyst precipitate from settling in feed tanks, which makes uniform catalyst feeding a potential problem. Thus, it is desirable to provide a catalyst solution made from M and aluminum.

### 3. SUMMARY OF THE INVENTION

There is now provided a composition comprising:
(i) M, wherein M is represented by an alkaline earth metal or alkali metal and
(ii) aluminum metal and
(iii) a mono-functional solvent comprising a mono-ol ether of a diol,
   wherein the molar ratio of M:Al ranges from 0.2:1 to 10:1.

The compositions are useful to catalyze (increase the reaction rate) the formation of polyester polymers when added to a melt phase process for the manufacture of the polymers.

The composition is desirably a solution which does not precipitate upon standing over a period of at least two days, or at least one week at room temperature (25° C.-35° C.). There is also provided a method for the manufacture of the composition, its feed to and use in the manufacture of a polyester polymer, and polyester polymers obtained by combining certain ingredients or containing the residues of these ingredients in the composition.

### 4. DETAILED DESCRIPTION OF THE INVENTION

The present invention may be understood more readily by reference to the following detailed description of the invention.

It must also be noted that, as used in the specification and the appended claims, the singular forms “a,” “an” and “the” include plural referents unless the context clearly dictates otherwise. For example, reference to processing or making a “polymer,” a “preform,” “article,” “container,” or “bottle” is intended to include the processing or making of a plurality of polymers, preforms, articles, containers or bottles.

References to a composition containing “an” ingredient or “a” polymer is intended to include other ingredients or other polymers, respectively, in addition to the one named.

By “comprising” or “containing” or “having” is meant that at least the named compound, element, particle, or method step etc. must be present in the composition or article or method, but does not exclude the presence of other compounds, catalysts, materials, particles, method steps, etc., even if the other such compounds, material, particles, method steps etc. have the same function as what is named, unless expressly excluded in the claims.

It is also to be understood that the mention of one or more method steps does not preclude the presence of additional method steps before or after the combined recited steps or intervening method steps between those steps expressly identified. Moreover, the lettering of process steps is a convenient means for identifying discrete activities or steps, and unless otherwise specified, recited process steps can be arranged in any sequence.

Expressing a range includes all integers and fractions thereof within the range. Expressing a temperature or a temperature range in a process, or of a reaction mixture, or of a melt or applied to a melt, or of a polymer or applied to a polymer means in all cases that the limitation is satisfied if either the applied temperature, the actual temperature of the melt or polymer, or both are at the specified temperature or within the specified range.

The word “composition” means that each listed ingredient is present in the composition, and does not imply that any ingredient in the composition is unbound or unreacted. The composition may be solid or liquid. The stated ingredients in the composition may be bound, unbound, reacted, unreacted, and unless otherwise specified, in any oxidation state. For example, specifying the presence of “aluminum” or “Al” or “lithium” or “Li” means the atoms of aluminum or lithium, respectively, and does not imply that they occupy any oxidation state, any morphological state, any structural state, or any chemical state, whether as added to or as present in the solution, polymer or composition of matter, unless such states are expressly stated.

As used herein, the term “metal” means the same as and is the equivalent of “atom,” and does not imply any oxidation state or its chemical state. Aluminum metal or an alkaline earth metal or alkali metal may be in any chemical state as a salt or chelate or complex or elemental, and in any oxidation state, unless otherwise expressly stated as having a particular oxidation state. The word “elemental,” however, means a zero oxidation state.

The It.V. values described throughout this description are set forth in dL/g units as calculated from the inherent viscosity measured at 25° C. in 60% phenol and 40% 1,1,2,2-tetrachloroethane by weight. Polymer samples are dissolved in the solvent at a concentration of 0.25 g/50 mL. The viscosity of the polymer solutions is determined using a Viscotek Modified Differential Viscometer. A description of the operating principle of the differential viscometers can be found in ASTM D 5225. The inherent viscosity is calculated from the measured solution viscosity. The following equations describe such solution viscosity measurements and subsequent calculations to Ih.V. and from Ih.V. to It.V:

ηᵢₙₕ=[ln(tₛ/tₒ)]/C
where
ηᵢₙₕ=Inherent viscosity at 25° C. at a polymer concentration of 0.5 g/100 mL of 60% phenol and 40% 1,1,2,2-tetrachloroethane by weight
ln=Natural logarithm
tₛ=Sample flow time through a capillary tube
tₒ=Solvent-blank flow time through a capillary tube
C=Concentration of polymer in grams per 100 mL of solvent (0.50%)

The intrinsic viscosity is the limiting value at infinite dilution of the specific viscosity of a polymer. It is defined by the following equation:

ηᵢₙₜ=lim(ηₛₚ/C)=lim(ln ηᵣ)/C C→0 C→0

where
ηᵢₙₜ=Intrinsic viscosity
ηᵣ=Relative viscosity=tₛ/tₒ
ηₛₚ=Specific viscosity=ηᵣ −1

Instrument calibration involves triplicate testing of a standard reference material and then applying appropriate mathematical equations to produce the “accepted” Ih.V. values. The three values used for calibration shall be within a range of 0.010; if not, correct problems and repeat testing of standard until three consecutive results within this range are obtained.

Calibration Factor=Accepted Ih.V. of Reference Material/Average of Triplicate Determinations

The uncorrected inherent viscosity (ηᵢₙₕ) of each sample is calculated from the Viscotek Model Y501 Relative Viscometer using the following equation:

ηᵢₙₕ=[ln(P₂/KP₁)]/C

### Where

P₂=The pressure in capillary P₂
P₁=The pressure in capillary P₁
ln=Natural logarithm
K=Viscosity constant obtained from baseline reading
C=Concentration of polymer in grams per 100 mL of solvent

The corrected Ih.V., based on calibration with standard reference materials, is calculated as follows:

Corrected Ih.V.=Calculated Ih.V.×Calibration Factor

The intrinsic viscosity (It.V. or ηᵢₙₜ) may be estimated using the Billmeyer equation as follows:

ηᵢₙₜ=0.5[e^{0.5×Corrected Ih.V.}−1]+(0.75×Corrected Ih.V.)

The reference for estimating intrinsic viscosity (Billmeyer relationship) is J. Polymer Sci., 4, pp. 83-86 (1949).

Alternatively, the It.V. can be measured using the above solvents and concentrations measured according to ASTM D 5225-98 using a differential viscometer to measure IV.

The weight of alkaline earth metal or alkali can be measured or calculated upon addition to the melt phase or by analytical techniques for detecting the amount in the finished polymer or article. Suitable detection methods for the presence of alkali metals or alkaline earth metals include inductively coupled plasma optical emission spectroscopy (ICP-OES). The concentration of an alkaline earth metal or an alkali metal or aluminum or phosphorus or any other element or metal is reported as the parts per million of metal atoms based on the weight of the polymer.

There is now provided a catalyst composition comprising:
(i) M, wherein M is represented by an alkaline earth metal or alkali metal and
(ii) aluminum metal and
(iii) a mono-functional solvent comprising a mono-ol ether of a diol,
   wherein the molar ratio of M:Al ranges from 0.2:1 to 10:1.

The composition is a catalyst solution for the manufacture of polycondensation polymers, including polyester polymers. The composition contains aluminum. The polyester polymers made with the compositions also contain aluminum. The presence of aluminum in the polyester polymer may be detected through any suitable analytical technique regardless of the oxidation state of the aluminum. Suitable detection methods for the presence of aluminum include inductively coupled plasma optical emission spectroscopy (ICP-OES). The concentration of aluminum is reported as the parts per million of metal atoms based on the weight of the polymer.

Reporting the concentration of aluminum or alkaline earth metal or alkali metals means the concentration of these atoms in the polymer, not the concentration of the metal compounds used to make the composition.

In the preparation of the composition, aluminum may be added as a compound (which includes a salt or a complex), or as an elemental metal provided that it is ultimately active as a catalyst in the polycondensation phase either alone or in combination with the alkali metal or alkaline earth metal atoms or compounds.

In one aspect of the invention, aluminum compounds with at least one organic substituent, or two, or three, are used in the preparation of the composition. Illustrative examples of suitable compounds suitable as catalysts include those of the formula:

Al[OR]ₐ[OR′]_{b}[OR″]_{c}[R′″]_{d}

wherein R, R′, R″ are independently an alkyl group, aryl group, acyl group or hydrogen, R′″ is an anionic group, and a, b, c, d are independently 0 or positive integers, and a+b+c+d is not greater than 3.

Aluminum compounds having catalytic activity include those which are capable of increasing the reaction rate of a polymerization reaction, in particular a condensation reaction such a those used to make polyester polymers (which can be measured as a reduction in residence time to reach a target It.V., or an increase in It.V. over time such as an increase of at least 0.1 dL/g over 1 hour). The particular aluminum compounds chosen are preferably those which are effective to increase the It.V. of the reaction melt by at least 0.2 dL/g within 1 hour.

It is desirable to use an aluminum compound which has a higher solubility in the solvent. Suitable examples of aluminum compounds include the carboxylic acid salts of aluminum such as aluminum acetate, aluminum benzoate, aluminum lactate, aluminum laurate, aluminum stearate, aluminum alcoholates such as aluminum ethylate, aluminum isopropylate, aluminum tri n-butyrate, aluminum isopropoxide, aluminum tri-tert-butyrate, mono-sec-butoxyaluminum diisopropylate, and aluminum chelates in which the alkoxy group of an aluminum alcoholate is partially or wholly substituted by a chelating agent such as an alkyl acetoacetate or acetylacetone such as ethyl acetoacetate aluminum diisopropylate, aluminum tris(ethyl acetate), alkyl acetoacetate aluminum diisopropylate, aluminum monoacetylacetate bis(ethyl acetoacetate), aluminum tris(acetyl acetate), aluminum acetylacetonate.

Preferred among the aluminum compounds are the basic carboxylic acid salts of aluminum and aluminum alcoholates. Basic carboxylic acid salts of aluminum include monobasic and dibasic compounds. The basic aluminum acetate used can be either the diacetate monohydroxy compound or the monoacetate dihydroxy compound or a mixture thereof. In one aspect, the aluminum compound comprises aluminum acetate and aluminum isoproxide. Aluminum isopropoxide is most preferred.

An amount of aluminum atoms, in combination with M, are employed to effect polycondensation once added to the melt phase polymerization process. Suitable amounts generally range from at least 3 ppm, or at least 5 ppm, or at least 10 ppm, or at least 15 ppm, or at least 20 ppm, or at least 30 ppm, and up to about 150 ppm, or up to about 100 ppm, or up to about 75 ppm, or up to about 60 ppm, or up to 30 ppm, or up to 20 ppm, or up to 15 ppm aluminum atoms based on the weight of the polymer. The preferred range of aluminum loading in the polyester polymer is, and the amount of aluminum atoms present in the composition fed to a melt phase polymerization reactor is effective to provide in the polymer, 5 ppm to 60 ppm, with the most preferred amount on a calculated basis ranging from 10 to 20 ppm Al based on the weight of the polymer.

Of course, the composition may and usually will contain a much higher concentration of the metals than present in the polyester polymer. The composition is fed to the melt phase at a rate corresponding to the desired amount of metal present in the polyester polymer. The composition may contain Al in an amount of from 1000 ppm, or at least 2000 ppm, or at least 5000 ppm, or at least 1 wt. %, or at least 2 wt. %, or at least 5 wt. % and up to an amount which does not cause the metal atoms to precipitate from the solution, such as up to 30 wt. %, or up to 20 wt. %, or up to 15 wt. %, or up to 10 wt. %, or up to 8 wt. %, based on the weight of the solution.

The alkali may be added as a metal compound or an organometallic compound. The alkali metals and alkaline earth metals include the metals in Group IA and Group IIA or the periodic table, including but not limited to Li, Na, K, Rb, Cs, Mg, Ca, Sr, and preferably Li, Na or K. If rapid rates are the primary concern, Li is most preferred. If color is the primary concern, Na is most preferred. The metals may be added to the melt phase as metal compounds (which includes a complex or a salt) having counterions, among which the preferred ones are hydroxides, carbonates, and carboxylic acids.

The amount of alkaline earth metal or alkali, in combination with Al, is effective to increase the molecular weight of the polymer melt. The amount by weight will vary widely depending upon the molecular weight of the metal. The amount of the alkaline earth metal or alkali metal in the composition may vary between at least 250 ppm, or at least 500 ppm, or at least 1000 ppm, or at least 2000 ppm, or at least 5000 ppm, or at least 1 wt. %, or at least 2 wt. %, and up to about 30 wt. %, or up to about 20 wt. %, or up to 15 wt. %, or up to 10 wt. %, based on the weight of the solution. The amount of alkaline earth metal or alkali metal fed to the melt phase polymerization process is effective to produce a polyester polymer composition containing, and the polyester polymer composition contains, from at least 1 ppm, or at least 2 ppm, or at least 3 ppm, or at least 4 ppm, or at least 5 ppm, and up to about 60 ppm, or up to about 50 ppm, or up to about 30 ppm, or up to about 20 ppm, or up to about 15 ppm, alkaline earth metal or alkali metal on a calculated basis and based on the weight of the polyester polymer composition. The particular amount of the alkaline earth metal or alkali metal in the polyester polymer again will vary depending upon the molecular weight of the metal.

The molar ratio of the alkaline earth metal or alkali:aluminum (M:Al) is desirably at least 0.2:1, or at least 0.5:1, or at least 0.75:1, or at least 0.9:1, or at least 1:1, or at least 1.25:1, or at least 2:1, and up to about 10:1, or up to 6:1, or up to 5:1, or up to 4:1, or up to 3:1, or up to 2:1, or up to 1.8:1, or up to 1.5:1, or up to 1.25:1. More examples of suitable ranges include 0.75:1 to 4:1, or 0.75:1 to 2:1, or 0.9:1 to 1.5:1. It is desirable to provide a large number of Al atoms to increase the catalytic activity of the catalyst system. Although not wishing to be bound to a theory, it is believed that aluminum is difficult to dissolve in ethylene glycol, and ethylene glycol has been a common carrier for a wide variety of solutions and/or dispersions since it is generally a reactant in the polymerization process for making a polyester polymer or is highly compatible with the melt. It is now possible, however, using the solvents described in the invention, to provide a solution which has a lower tendency to precipitate even at higher levels of aluminum. It is desirable to use a M:Al ratio lower than 6:1, such as within a range of 0.2:1 to 4:1 or 0.2:1 to 2:1, so as to provide a composition which is has good activity and imparts high conversion or lower residence time to a target It.V.

The solvent employed in the invention keeps the alkaline earth metal or alkali metal and aluminum metal combinations in solution when standing without agitation over a period of at least two (2) days at room temperature (e.g. a temperature between 25° C. and 35° C.). The rate of precipitation is reduced using certain solvent, even when the amount of aluminum is increased as the mole ratio of M:Al is decreased, such as lower than 4:1. The solvent employed in the invention is a mono-ol ether solvent. Preferably, the solvent keeps the alkaline earth metal or alkali metals and aluminum metal combinations in solution when standing without agitation over a period of at least seven (7) days.

The solvent compound contains one or more residues of, or is made by reacting, a diol compound. The diol compound is any dihydroxy functional compound having from 2 to 24 carbon atoms, or 2 to 18 carbon atoms, or 2 to 14 carbon atoms, or 2 to 8 carbon atoms, or 2 to 4 carbon atoms. Examples include ethylene glycol, 1,3 propane diol, 1,4-butane diol, 1,2-propane diol, and 1,5-pentane diol.

The solvent compound contains one or more ether groups. Desirably, the number of ether groups ranges from 1 to 5, or 1 to 4, or 1 to 3. The solvent compound is also a mono-ol, meaning that only one of the hydroxyl groups from the diol is available for reaction. The other hydroxyl group is reacted to form an ether group. Functional groups other than and in addition to the mono-hydroxyl group may be present on the solvent compound. However, it is desirable that the hydroxyl group is the only reactive functionality on the solvent compound.

The amount of mono-ol ether solvent is sufficient to keep the aluminum and alkaline earth metal or alkali metals in solution. Suitable amounts generally range from 30 wt. %, or from 35 wt. %, or from 40 wt. %, or from 45 wt. %, or from 50 wt. %, and up to about 98 wt. %, or up to 95 wt. %, or up to 90 wt. %, or up to 85 wt. %, or up to 80 wt. %, or up to 75 wt. %, or up to 70 wt. %, based on the weight of the solution. The mono-ol ether solvent may be the sole solvent or may be combined with other diluents, solvents, or liquid carriers.

The number average molecular weight of the solvent desirably ranges from greater than 62, or at least 78, or at least 90, and less than 300, or up to about 250, or up to about 200. Higher molecular weights may be used provided that they make a solution, but lower molecular weights are preferred to more readily evaporate the solvent from the rection mixture or melt once added to the melt phase for making the polyester polymer.

Examples of the mono-ether solvent include 2-methoxyethanol, ethylene glycol butyl ether, ethylene glycol monophenyl ether, and 2-isopropoxyethanol.

The composition is prepared by combining the alkaline earth metal or alkali salts with the aluminum compounds, preferably a tridentate aluminum compound, adding the mono-ol ether solvent, and stirring the mixture at a temperature ranging from 20° C. to 150° C., or at 80° C. to 140° C. The total weight percent of aluminum in the solution may range from 0.1 to 1.2 based on the weight of the composition. For example, lithium hydroxide monohydrate and aluminum isopropoxide can be combined together at a lithium-aluminum mole ratio from 1:1 to 5:1 with 2-methoxy ethanol or ethylene glycol butyl ether and heating, with stirring, to 100-125° C. for 1-3 hours to form a solution. To determine whether a given composition is a solution, a measurement of the composition can be taken to determine whether visible to the naked eye any precipitation occurs by allowing the solution to stand still without agitation over a period of at least two days, preferably at least 7 days, at ambient conditions, or at 25° C. and 1 atm. In another embodiment, the solubility of (i) and (ii) in the solvent at the given concentrations in a particular composition is sufficiently high such than no precipitation is visible to the naked eye when the solution is allowed to stand still over a period of period of at least 4 days, or at least 6 days, or at least 1 week, or at least 2 weeks, or at least 3 weeks.

In some cases, the byproduct of the reaction between the metal compounds used to make the catalyst solution can severely discolor the solution. The catalyst solution discoloration is not expected to discolor the polymer once the catalyst solution is added to the melt phase polymerization reaction since small quantities of solution are added to the melt phase process for making the polymer. However, in the event that polymer discoloration would result, or in the event that one desires to nevertheless avoid discoloration of the solution for any reason, there is now also provided a process for making the solution comprising combining a composition containing M, Al, and the mono-ol ether solvent to an inert gas sweep. An example of a suitable inert gas sweep is a gas having a nitrogen concentration richer than that found in the atmosphere, typically containing at least 90% nitrogen. The volumetric flow rate is not particularly limited and can be easily adjusted to maintain the coloration of the solution within desired limits. Typical flow rates are at least 0.5 standard cubic feet per hour (SCFH), or at least 0.75 SCFH, or at least 1 SCFH or at least 2 SCFH. Without being bound to a theory, it is believed that the inert gas sweep will promote the escape from the solution of volatile by-products, such as acetaldehyde, that contribute to the formation of color bodies. The inert gas is swept across a surface of the solution for at least a portion of the heating cycle during which the solution is made to become soluble. In another aspect, the solution is subjected to a gas sweep at least at the time when the solution obtains its highest temperature during preparation.

There is also now provided a polyester polymer composition comprising a catalyst system and a polyester polymer, said catalyst system obtained by combining
(i) M, wherein M is represented by an alkaline earth metal or alkali metal and
(ii) aluminum metal and
(iii) a mono-ol ether solvent,
   wherein the molar ratio of M:Al ranges from 0.2:1 to 10:1.

The aluminum metal is typically combined with (i) and (iii) in the form of a salt or compound, as is M, as noted above.

The polyester polymer produced in the melt phase may contain phosphorus atoms. Phosphorus may be added late in the melt phase polymerization process to deactivate or stabilize the catalyst system, thereby reducing the haze level of the polymer, bottle preforms, and bottles made thereby, even at high catalyst loadings. The polyester polymer may contain phosphorus atoms in an amount ranging from 3 ppm to 500 ppm, based on the weight of the polymer composition. The amount of phosphorus is desirably at a mole ratio of P:M (all metals of aluminum and alkaline earth metals and alkali metals) within a range of 0.5:1 to 3:1. Typical amounts of phosphorus atoms will be at least 3 ppm, or at least 5 ppm, or at least 10 ppm, or at least 50 ppm, or at least 100 ppm, and up to 500 ppm, or up to 200 ppm, or up to 100 ppm, or up to 50 ppm, or up to 30 ppm, or up to 15 ppm. The solution haze values of these polymers can be as low as 30 ntu or less, or 20 ntu or less, or 15 ntu or less, or 10 ntu or less. The relative reduction of haze by addition of phosphorus is as large as 40% or more, or 50% or more, or 60% or more, relative to the same polymer made without phosphorus.

Other catalyst metals may be present if desired. For example, Mn, Zn, Sb, Co, Ti, and Ge catalysts may be used in conjunction with aluminum and alkaline earth metals or akali catalysts. Preferably, the polyester polymer is made without the addition of cobalt to the melt phase reaction since organic toners are preferred. Titanium catalysts can be used. The titanium catalysts are those compounds added in amounts which increase the It.V. of polyester melt by at least 0.3 dL/g if not deactivated. The amount of titanium catalyst, if used, generally ranges from 2 ppm to 15 ppm, or up to 10 ppm, based on the weight of the polymer. Antimony catalysts can also be used in combination with the catalyst system of the invention. The amount of antimony can range from 20 ppm to 250 ppm. Due to M generation concerns, the amount of antimony is preferred to be no greater than 125 ppm, based on the weight of the polymer, and preferably there is provided a polyester polymer which does not contain any antimony added to its manufacture in the melt phase.

In one embodiment, the polyester polymer contains aluminum, alkaline earth metal or alkali metals, and does not contain any antimony catalyst in catalytic quantities, or does not contain any cobalt catalyst in catalytic quantities, or does not contain any titanium catalyst in catalytic quantities, or does not contain any germanium catalyst in catalytic quantities, or does not contain any combination of Ti, Co, Sb, or Ge based catalysts in catalytic quantities, or does not contain any of the aforementioned catalyst metals (other than Al and alkaline earth metal or alkali metals) added to the polymer during its manufacture in the melt phase, or does not contain any catalyst metals other than aluminum and an alkaline earth metal or alkali. A catalyst metal is said to have catalytic activity if it increases the reaction rate or increases the It.V. of the melt by at least 0.1 dL/g from a starting point of 0.2 to 0.4 dL/g after 1 hour at 280° C. and 0.8 mm Hg. It is to be recognized, however, that one or more of metals such as cobalt or manganese will most likely be present at low levels in the melt because they come as impurities with the terephthalic acid composition made from a metal-catalyzed, liquid-phase oxidation process. Metal impurities present in the raw material supply to the melt phase process are not considered to be metals added to the melt phase process and they are not present in any event in catalytically effective quantities.

The “polyester polymer” is any thermoplastic polyester polymer. Polyester thermoplastic polymers of the invention are distinguishable from liquid crystal polymers and thermosetting polymers in that thermoplastic polymers have no appreciable ordered structure while in the liquid (melt) phase, they can be remelted and reshaped into a molded article, and liquid crystal polymers and thermosetting polymers are unsuitable for the intended applications such as packaging or stretching in a mold to make a container.

The polyester polymer is desirably a random polymer such that the monomer units in the polymer chain are randomly arranged rather than arranged in a block fashion. The polyester polymer contains repeating alkylene aryl units, such as alkylene terephthalate or alkylene naphthalate repeat units in the polymer chain. More specific examples of these repeating units include ethylene terephthalate, ethylene naphthalate, and trimethylene terephthalate.

More preferred are polyester polymers which comprise:
(i) a carboxylic acid component comprising at least 80 mole % of the residues of terephthalic acid, derivates of terephthalic acid, naphthalene-2,6-dicarboxylic acid, derivatives of naphthalene-2,6-dicarboxylic acid, or mixtures thereof, and
(ii) a hydroxyl component comprising at least 80 mole % of the residues of ethylene glycol or propane diol,
   based on 100 mole percent of carboxylic acid component residues and 100 mole percent of hydroxyl component residues in the polyester polymer.

Typically, polyesters such as polyethylene terephthalate are made by reacting a diol such as ethylene glycol with a dicarboxylic acid as the free acid or its C₁-C₄ dialkyl ester to produce an ester monomer and/or oligomers, which are then polycondensed to produce the polyester. More than one compound containing carboxylic acid group(s) or derivative(s) thereof can be reacted during the process. All the compounds that enter the process containing carboxylic acid group(s) or derivative(s) thereof that become part of said polyester product comprise the “carboxylic acid component.” The mole % of all the compounds containing carboxylic acid group(s) or derivative(s) thereof that are in the product add up to 100. The “residues” of compound(s) containing carboxylic acid group(s) or derivative(s) thereof that are in the said polyester product refers to the portion of said compound(s) which remains in the said polyester product after said compound(s) is condensed with a compound(s) containing hydroxyl group(s) and further polycondensed to form polyester polymer chains of varying length.

More than one compound containing hydroxyl group(s) or derivatives thereof can become part of the polyester polymer product(s). All the compounds that enter the process containing hydroxyl group(s) or derivatives thereof that become part of said polyester product(s) comprise the hydroxyl component. The mole % of all the compounds containing hydroxyl group(s) or derivatives thereof that become part of said polyester product(s) add up to 100. The “residues” of hydroxyl functional compound(s) or derivatives thereof that become part of said polyester product refers to the portion of said compound(s) which remains in said polyester product after said compound(s) is condensed with a compound(s) containing carboxylic acid group(s) or derivative(s) thereof and further polycondensed to form polyester polymer chains of varying length.

The mole % of the hydroxyl residues and carboxylic acid residues in the product(s) can be determined by proton NMR.

In another preferred embodiment, the polyester polymer comprises:
(a) a carboxylic acid component comprising at least 90 mole %, or at least 92 mole %, or at least 96 mole % of the residues of terephthalic acid, derivates of terephthalic acid, naphthalene-2,6-dicarboxylic acid, derivatives of naphthalene-2,6-dicarboxylic acid, or mixtures thereof, more preferably terephthalic acid or derivates of terephthalic acid, and
(b) a hydroxyl component comprising at least 90 mole %, or at least 92 mole %, or at least 96 mole % of the residues of ethylene glycol or propane diol, more preferably ethylene glycol,
   based on 100 mole percent of the carboxylic acid component residues and 100 mole percent of the hydroxyl component residues in the polyester polymer.

The reaction of the carboxylic acid component with the hydroxyl component during the preparation of the polyester polymer is not restricted to the stated mole percentages since one may utilize a large excess of the hydroxyl component if desired, e.g. on the order of up to 200 mole % relative to the 100 mole % of carboxylic acid component used. The polyester polymer made by the reaction will, however, contain the stated amounts of aromatic dicarboxylic acid residues and ethylene glycol residues.

Derivates of terephthalic acid and naphthalane dicarboxylic acid include C₁-C₄ dialkylterephthalates and C₁-C₄ dialkylnaphthalates, such as dimethylterephthalate and dimethylnaphthalate.

Modifiers can be present in amount of up to 40 mole %, or up to 20 mole %, or up to 10 mole %, or up to 8 mole %, or up to 4 mole %, based on the total moles of their respective component in the polymer. Mono, tri and higher functional modifiers are preferably present in amounts of only up to about 8 mole %, or up to 4 mole %.

In addition to a diacid component of terephthalic acid, derivates of terephthalic acid, naphthalene-2,6-dicarboxylic acid, derivatives of naphthalene-2,6-dicarboxylic acid, or mixtures thereof, the carboxylic acid component(s) of the present polyester may include one or more additional modifier carboxylic acid compounds. Such additional modifier carboxylic acid compounds include mono-carboxylic acid compounds, dicarboxylic acid compounds, and compounds with a higher number of carboxylic acid groups. Examples include aromatic dicarboxylic acids preferably having 8 to 14 carbon atoms, aliphatic dicarboxylic acids preferably having 4 to 12 carbon atoms, or cycloaliphatic dicarboxylic acids preferably having 8 to 12 carbon atoms. More specific examples of modifier dicarboxylic acids useful as an acid component(s) are phthalic acid, isophthalic acid, naphthalene-2,6-dicarboxylic acid, cyclohexane-1,4-dicarboxylic acid, cyclohexanediacetic acid, diphenyl-4,4′-dicarboxylic acid, succinic acid, glutaric acid, adipic acid, azelaic acid, sebacic acid, and the like, with isophthalic acid, naphthalene-2,6-dicarboxylic acid, and cyclohexane-1,4-dicarboxylic acid being most preferable. It should be understood that use of the corresponding acid anhydrides, esters, and acid chlorides of these acids is included in the term “carboxylic acid”. It is also possible for tricarboxyl compound branching agents and compounds with a higher number of carboxylic acid groups to modify the polyester, along with monocarboxylic acid chain terminators.

In addition to a hydroxyl component comprising ethylene glycol, the hydroxyl component of the present polyester may include additional modifier mono-ols, diols, or compounds with a higher number of hydroxyl groups. Examples of modifier hydroxyl compounds include cycloaliphatic diols preferably having 6 to 20 carbon atoms and/or aliphatic diols preferably having 3 to 20 carbon atoms. More specific examples of such diols include diethylene glycol; triethylene glycol; 1,4-cyclohexanedimethanol; propane-1,3-diol; butane-1,4-diol; pentane-1,5-diol; hexane-1,6-diol; 3-methylpentanediol-(2,4); 2-methylpentanediol-(1,4); 2,2,4-trimethylpentane-diol-(1,3); 2,5-ethylhexanediol-(1,3); 2,2-diethyl propane-diol-(1,3); hexanediol-(1,3); 1,4-di-(hydroxyethoxy)-benzene; 2,2-bis-(4-hydroxycyclohexyl)-propane; 2,4-dihydroxy-1,1,3,3-tetramethyl-cyclobutane; 2,2-bis-(3-hydroxyethoxyphenyl)-propane; and 2,2-bis-(4-hydroxypropoxyphenyl)-propane.

As modifiers, the polyester polymer may preferably contain such comonomers as isophthalic acid, naphthalane dicarboxylic acid, 1,4-cyclohexanedimethanol, and diethylene glycol.

The polyester composition may include blends of polyalkylene terephthalates and/or polyalkylene naphthalates along with other thermoplastic polymers such as polycarbonate (PC) and polyamides. It is preferred that the polyester composition should comprise a majority of the polyester polymers, more preferably in an amount of at least 80 wt. %, or at least 95 wt. %, and most preferably 100 wt. %, based on the weight of all thermoplastic polymers (excluding fillers, inorganic compounds or particles, fibers, impact modifiers, or other polymers which may form a discontinuous phase). It is also preferred that the polyester polymers do not contain any fillers, fibers, or impact modifiers or other polymers which form a discontinuous phase.

In one embodiment, the composition contains less than 60 wt %, or less than 40 wt %, or less than 20 wt. %, or less than 10 wt. %, or less than 5 wt. %, or no post consumer recycle polyester polymer (“PCR”) present in the composition. In another embodiment, the composition contains PCR in an amount of greater than zero and up to 60 wt. %, or up to 40 wt. %, or up to 20 wt %, or up to 10 wt. %.

Specific examples of the phosphorus compounds mentioned above as suitable catalyst deactivators and/or stabilizers include phosphoric acid, pyrophosphoric acid, phosphorous acid, polyphosphoric acid, carboxyphosphonic acids, phosphonic acid derivatives, and each of their acidic salts and acidic esters and derivatives, including acidic phosphate esters such as phosphate mono- and di-esters and non-acidic phosphate esters (e.g. phosphate tri-esters) such as trimethyl phosphate, triethyl phosphate, tributyl phosphate, tributoxyethyl phosphate, tris(2-ethylhexyl) phosphate, oligomeric phosphate tri-esters, trioctyl phosphate, triphenyl phosphate, tritolyl phosphate, (tris)ethylene glycol phosphate, triethyl phosphonoacetate, dimethyl methyl phosphonate, tetraisopropyl methylenediphosphonate, mono-, di-, and tri-esters of phosphoric acid with ethylene glycol, diethylene glycol, or 2-ethylhexanol, or mixtures of each. Other examples include distearylpentaerythritol diphosphite, mono- and di-hydrogen phosphate compounds, phosphite compounds, certain inorganic phosphorus compounds that are preferably soluble in the polymer melt, poly(ethylene)hydrogen phosphate, silyl phosphates; phosphorus compounds used in combinations with hydroxy- or amino-substituted carboxylic acids, such as methyl salicylate, maleic acid, glycine, or dibutyl tartrate; each useful for inactivating metal catalyst residues. Haze in solutions of particles or in molded parts is one indication of lack of solubility. Soluble additives are more likely to deactivate/stabilize the catalyst system.

Other phosphorus compounds which may be added include the amine salts of phosphorus-containing acids. The amines may be cyclic or acyclic, may be monomeric, oligomeric, or polymeric, and should be selected so as to minimize haze and/or solubility when the latter are issues. The organic constituents of the amine may in principle be any organic group. Ammonia and related compounds like ammonium hydroxide are suitable.

To minimize It.V. loss if large quantities of phosphorus are added, or to further minimize the potential It.V. loss even if moderate or optimal quantities of phosphorus are added, it is desirable to add the phosphorus compound neat, that is without further dilution, such as in the case of 85% or more phosphoric acid. If a carrier is used, it is preferred that that the carrier is nonreactive, that is, does not break the polymer chain nor increase AA generation rates. Water, alcohols, glycols and lower molecular weight PET are known to break the polymer chain. Once the minimum amount of the phosphorus compound and the associated It.V. loss are known, the melt-phase process can be carried out such that the It.V, made before deactivation/stabilization, is higher by the amount of It.V. loss expected so that the target ItV. can be achieved.

The melt phase reaction proceeds in a batch, semi-batch, or continuous mode. Preferably, the process of the invention is continuous.

The composition is desirably added after completion of esterification, or between the esterification zone and polycondensation zone, or at a point when polycondensation starts, or during prepolymerization. In one embodiment, the alkaline earth metal or alkali compounds are added after 50% conversion of the esterification reaction mixture. In another embodiment, the composition is added between the esterification zone and inception of or during polycondensation or at the inception of or during prepolymerization.

In a preferred embodiment, the composition is added to the oligomer mixture upon or after completion of esterification (at least 90% conversion) or to a polyester melt no later than when the It.V. of the melt reaches 0.3 dL/g, or no later than when the It.V. of the melt reaches 0.2 dL/g, and more preferably to the oligomer mixture exiting the esterification zone or prior to commencing or at the start of polycondensation.

If the molar ratio of the catalyst solution is not the molar ratio of M:Al desired in the melt phase to polymerize the polyester melt, the present invention allows one the flexibility of feeding to the melt phase a stream of the stable catalyst solution of the invention while also feeding to the melt phase process a separate stream of alkaline earth metal or alkali M. In this way, one obtains the benefit of having a stable catalyst solution, while retaining the flexibility of adjusting the molar ratio of M:Al on a manufacturing line as high as desired to obtain a variety of polymers having differing characteristics. Thus, the catalyst solution of the invention containing the Al metal and the alkaline earth metal or alkali metals can be fed at any point in the melt phase process as described above, while simultaneously feeding a separate stream of alkaline earth metal or alkali M earlier or later or at the same feed point as the catalyst solution feed point, preferably earlier or at the same point, to adjust the desired M:Al molar ratio as needed. For example, a stream of the alkaline earth metal or alkali M can be fed to the esterification zone and before 90% conversion, or before 70% conversion, or before 50% conversion, or before 40% conversion, or before 20% conversion, while the catalyst solution can be fed at a point between 90% conversion in esterification and the polycondensation zone when the It.V. of the melt is less than 0.3 dL/g. Both feeds can occur simultaneously in a continuous process for making the polyester polymer.

In one embodiment where the phosphorus compound is added to a melt phase polymerization process, the catalyst stabilizer is added to the polyester melt late during the course of polycondensation and before solidification. The deactivator is added to the polyester melt late in the course of the polycondensation reaction when one or more of the following conditions are satisfied or thereafter and before solidification of the polyester melt:
a) the polyester melt reaches an It.V. of at least 0.50 dL/g or
b) vacuum applied to the polyester melt, if any, is released, or
c) if the polyester melt is present in a melt phase polymerization process, adding the phosphorus compound within a final reactor for making the polyester polymer or between the final reactor and before a cutter for cutting the polyester melt, or
d) if the polyester melt is present in a melt phase polymerization process, following at least 85% of the time for polycondensing the polyester melt; or
e) the It.V. of the polyester melt is within +/−0.15 dl/g of the It.V. obtained upon solidification; or
f) at a point within 20 minutes or less of solidifying the polyester melt.

In one embodiment, the deactivator is added to the polyester melt after the polyester melt obtains an It.V. of at least 0.50 dL/g, or at least 0.55 dL/g, or at least 0.60 dL/g, or at least 0.65 dL/g, or at least 0.68 dL/g, or at least 0.70 dL/g, or at least 0.72 dL/g or at least 0.76 dL/g, or at least 0.78 dL/g, and most preferably, regardless of when the deactivator is added, the resulting polymer exiting the melt phase manufacture has an It.V. of at least 0.68 dl/g.

In another embodiment, the deactivator is added to the polyester melt during or after releasing the vacuum from the polyester melt undergoing polycondensation reactions, or after bringing the pressure in a polycondensation zone or reactor to a level of 300 mm Hg or greater, or 450 mm Hg or greater, or 600 mm Hg or greater, or to atmospheric pressure or greater, and preferably before the polyester melt is solidified.

In another embodiment, the deactivator is added at a location near or at the end of a final reactor or between the final reactor and before a cutter. For example, the deactivator is added to the last polycondensation reactor at a location proximal to the outlet of the last polycondensation reactor, or to a pipe connecting directly or indirectly the last polycondensation reactor and a gear pump or extruder providing the motive force to drive the melt through a die plate for cutting wherein said pipe is directed back to or proximal to the outlet or the bottom of the last polycondensation reactor, or to a pipe inlet to the last polycondensation reactor.

In yet another embodiment, the deactivator is added to the polyester melt following at least 85%, or at least 90%, or at least 95%, or at least 98%, or about 100% of the polycondensation time. The polycondensation time is measure as the time elapsed between the start of polycondensation zone to the exit of the polyester melt from the last polycondensation reactor.

In a further embodiment, the deactivator is added to the polyester melt when the It.V. of the polyester melt is within 0.10 dL/g, or within 0.05 dl/g, or within 0.030 dL/g, or within 0.02 of the It.V. obtained upon solidification.

In yet another embodiment, the deactivator is added to the polyester melt at a point within 20 minutes, or within 10 minutes or less, or 5 minutes or less, or 3 minutes or less of solidifying the polyester melt. The solidification of the polyester melt typically occurs when the melt is forced through a die plate into a water bath and cut into pellets, or in a melt-to-mold process when the melt is injection molded into a molded article.

In yet a more preferred embodiment, each of the embodiments identified herein occurs in a continuous manufacturing process where the throughput of the melt phase process is at least 1 ton/day, or at least 50 tons/day, or at least 100 tons/day, or at least 200 tons/day, or at least 300 tons/day, or at least 400 tons/day, or at least 500 tons/day of polyester polymer in a steady state operation.

The reaction time of the melt from an It.V. of 0.40 dL/g through and up to an It.V. in the range of at least 0.68 dL/g to 0.94 dL/g is 150 minutes or less, or 120 minutes or less, or 90 minutes or less, or 50 minutes or less. The target It.V. is preferably between 0.84 and 0.94 dL/g prior to deactivation/stabilization, the vacuum applied is preferably between 0.5 and 1.0 torr, and temperature is preferably between 275° C. to 285° C.

Stabilizing or deactivating the catalyst late or near the end of a melt phase process can result in polyester particles that, in the absence of acetaldehyde (AA) scavengers, generate less AA during subsequent melt processing. With late addition of a phosphorus compound, Al/alkaline earth metal or alkali catalyst systems can produce polyester polymers with lower AA generation rates than polyester polymers made without the presence of a catalyst deactivator or polyesters made with conventional antimony catalysts that are similarly deactivated late with a phosphorus compound. With late addition of a phosphorus compound to the polyester melt catalyzed with an aluminum/alkaline earth metal or alkali system, it is now possible to obtain a polyester polymer having free AA levels and an AA generation rate low enough for use in water bottle applications without the need to add AA scavengers or other AA lowering additives. Moreover, this type of polymer having both low free AA levels and low AA generation rates without the presence of an AA lowering additive can be obtained to a high It.V. (at least 0.68 dL/g, or at least 0.70 dL/g, or at least 0.72 dL/g, or at least 0.74 dL/g, or at least 0.76 dL/g, or at least 0.80 dL/g, or at least 0.84 It.V.) in the melt phase without the necessity for polymerizing the polymer in the solid-state. Some catalyst combinations, some phosphorus levels in PET from late addition, and some water bottle specifications may necessitate a brief AA stripping treatment to lower free M below 6 ppm or below 4 ppm or below 2 ppm prior to beginning the injection molding process.

The polyester polymer compositions made with the composition, when partially crystallized to a degree of crystallinity of at least 20%, have an L* of at least 70, or at least 73, or at least 76, or at least 79, and an It.V. of at least 0.70 dL/g, or at least 0.72 dL/g, or at least 0.76 dL/g obtained from the melt phase.

The particles of the invention are directly or indirectly packaged as a bulk into shipping containers, which are then shipped to customers or distributors. It is preferred to subject the crystallized particles to any process embodiment described herein without solid state polymerizing the particles at any point prior to packaging the particles into shipping containers.

Shipping containers are containers used for shipping over land, sea or air. Examples include railcars, semi-tractor trailer containers, Gaylord boxes, ship hulls, or any other container which is used to transport finished polyester particles to a customer. Customers are typically converter entities who convert the particles into preforms or other molded articles.

The shipping containers contain a bulk of polyester polymer particles. A bulk occupies a volume of at least 3 cubic meters. In preferred embodiments, the bulk in the shipping container occupies a volume of at least 5 cubic meters, or at least 10 cubic meters.

In one embodiment, there is provided finished polyester polymer particles having an average It.V. of at least 0.68 dL/g, or 0.70 dL/g, or 0.72 dL/g, or 0.74 dL/g, or 0.76 dL/g, obtained in a melt phase polymerization and a residual acetaldehyde level of 10 ppm or less or of 5 ppm or less; wherein said particles contain aluminum in an amount of at least 3 ppm, or at least 5 ppm, or at least 10 ppm, or at least 15 ppm, or at least 20 ppm based on the weight of the polymers, and further contain the residues of a mono-ol ether solvent either reacted into the polyester chain, reacted as an end group on the polyester chain, or reacted on a polyester polymer by transesterification. At least a portion of the solvent may be reacted into the polyester chain during melt phase polymerization such that the polyester polymer contains an end group of the mono-ol ether solvent. Another portion of the solvent may be removed from the polycondensation vessels via the vacuum system. Preferably, the polyester particles in the shipping container also have a degree of crystallinity of at least 20%, preferably at least 30%; and the particles also contain a nonzero level of an alkaline earth metal or alkali metal, along with a nonzero level of phosphorus. The particles are desirably contained in a shipping container. Most preferably, the particles have not been solid state polymerized. By “finished” particles is meant particles that have been subjected by the particle manufacturer to all the processing conditions needed to produce a particle ready for feeding into dryer hoppers associated with a molding machine or directly to a molding machine used for converting particles into articles, without any further processing steps performed by the particle manufacturer.

Suitable articles which are formed from the polyester polymer compositions manufactured with the composition of the invention are sheets, bottle preforms, beverage bottle preforms, and blow molded bottles made therefrom.

This invention can be further illustrated by the additional examples of embodiments thereof, although it will be understood that these examples are included merely for purposes of illustration and are not intended to limit the scope of the invention.

### EXAMPLES

The compositions of the invention may exhibit haziness yet constitute solutions in which no precipitation occurs. Precipitates are deemed formed when by the eye one can observe the presence of the catalyst metal particulates settled at the bottom of the vessel.

### Example 1

### A 1:1 Li/Al Solution in 2-Methoxy Ethanol at 0.3 wt % Al

A scintillation vial was charged with 227 mg aluminum isopropoxide [Al(OⁱPr)₃], 46 mg lithium hydroxide monohydrate [LiOH.H₂O], and 10.0 g of anhydrous 2-methoxy ethanol. A stirbar was added, the vial was sealed, and the contents were heated with stirring to 100° C. in an oil bath for 2 hours. A clear and colorless solution was obtained. The vial was removed from the oil bath and allowed to stand at ambient temperature for 6 days. No precipitation or other change was observed over this time frame.

### Example 2

### A 3:1 Li/Al Solution in 2-Methoxy Ethanol at 0.3 wt % Al

A scintillation vial was charged with 227 mg aluminum isopropoxide [Al(OⁱPr)₃], 140 mg lithium hydroxide monohydrate [LiOH.H₂O], and 10.0 g of anhydrous 2-methoxy ethanol. A stirbar was added, the vial was sealed, and the contents were heated with stirring to 110° C. in an oil bath for 2 hours. A clear, light orange solution was obtained. The vial was removed from the oil bath and allowed to stand at ambient temperature for 7 days. No precipitation or other change was observed over this time frame.

### Example 3

### A 2.2:1 Li/Al Solution in Ethylene Glycol Butyl Ether at 0.3 wt % Al

A scintillation vial was charged with 227 mg aluminum isopropoxide [Al(OⁱPr)₃], 103 mg lithium hydroxide monohydrate [LiOH.H₂O], and 10.0 g of ethylene glycol butyl ether. A stirbar was added, the vial was sealed, and the contents were heated with stirring to 110° C. in an oil bath for 2 hours. A clear, light orange solution was obtained. No precipitation was observed from this solution upon standing for over one week at room temperature.

### Example 4

### A 5:1 Li/Al Solution in 2-Methoxy Ethanol at 0.3 wt % Al

A scintillation vial was charged with 227 mg aluminum isopropoxide [Al(OⁱPr)₃], 233 mg lithium hydroxide monohydrate [LiOH.H₂O], and 10.0 g of anhydrous 2-methoxy ethanol. A stirbar was added, the vial was sealed, and the contents were heated with stirring to 110° C. in an oil bath for 3 hours. A clear, orange solution was obtained. The vial was removed from the oil bath and allowed to stand at ambient temperature for 1 week. No precipitation or other change was observed over this time frame.

### Example 5

### A 1:1 Li/Al Solution in Ethylene Glycol Butyl Ether at 0.3 wt % Al

A scintillation vial was charged with 227 mg aluminum isopropoxide [Al(OⁱPr)₃], 46 mg lithium hydroxide monohydrate [LiOH.H₂O], and 10.0 g of ethylene glycol butyl ether. A stirbar was added, the vial was sealed, and the contents were heated with stirring to 110° C. in an oil bath for 3 hours. A clear, light yellow solution was obtained. No precipitation was observed from this solution upon standing for over one week at room temperature.

### Example 6

### A 3:1 Li/Al Solution in Ethylene Glycol Butyl Ether at 0.3 wt % Al

A scintillation vial was charged with 227 mg aluminum isopropoxide [Al(OⁱPr)₃], 140 mg lithium hydroxide monohydrate [LiOH.H₂O], and 10.0 g of ethylene glycol butyl ether. A stirbar was added, the vial was sealed, and the contents were heated with stirring to 110° C. in an oil bath for 3 hours. A clear, light yellow solution was obtained. No precipitation was observed from this solution over one week upon standing at room temperature.

### Example 7

### A 3:1 Li/Al Solution in 2-Isopropoxyethanol at 0.3 wt % Al

A scintillation vial was charged with 227 mg aluminum isopropoxide [Al(OⁱPr)₃], 140 mg lithium hydroxide monohydrate [LiOH.H₂O], and 10.0 g of 2-isopropoxyethanol. A stirbar was added, the vial was sealed, and the contents were heated with stirring to 125° C. in an oil bath for 3 hours. A clear, reddish-orange solution was obtained. No precipitation was observed from this solution upon standing for over one week at room temperature.

What we claim is:

1. A composition comprising:
(i) M, wherein M is represented by an alkaline earth metal or alkali metal and
(ii) aluminum metal and
(iii) a mono-ol ether solvent,
wherein the molar ratio of M:Al ranges from 0.2:1 to 10:1.

2. The composition of claim 1, wherein the composition is a solution.

3. The composition of claim 2, wherein the composition is a solution when measured as over a period of at least 6 days at about 25° C. and about 1 atm.

4. The composition of claim 1, wherein aluminum is obtained from an aluminum compound.

5. The composition of claim 4, wherein the aluminum compound is represented by the formula:
Al[OR]ₐ[OR′]_{b}[OR″]_{c}[R′″]_{d}
wherein R, R′, R″ are independently an alkyl group, aryl group, acyl group or hydrogen, R′″ is an anionic group, and a, b, c, d are independently 0 or positive integers, and a+b+c+d is not greater than 3.

6. The composition of claim 4, wherein the aluminum compound comprises carboxylic acid salts of aluminum.

7. The composition of claim 6, wherein the aluminum compound comprises basic carboxylic acid salts of aluminum or aluminum alcoholates.

8. The composition of claim 7, wherein the carboxylic acid salt of aluminum comprises a diacetate monohydroxy compound or the monoacetate dihydroxy compound or a mixture thereof.

9. The composition of claim 2, wherein the aluminum is obtained from aluminum acetate or aluminum isoproxide or both.

10. The composition of claim 1, wherein the composition is a solution containing at least 1000 ppm aluminum based on the weight of the composition.

11. The composition of claim 10, wherein the solution contains at least 1 wt. % aluminum based on the weight of the composition.

12. The composition of claim 11, wherein the solution contains from at least 2 wt. % up to 20 wt. % aluminum based on the weight of the composition.

13. The composition of claim 12, wherein the solution contains from at least 2 wt. % up to 10 wt. % aluminum atoms.

14. The composition of claim 1, wherein the alkali metals or alkaline earth metals comprise lithium, sodium, potassium, or combination thereof.

15. The composition of claim 14, wherein the alkaline earth metal or alkali metal comprises Li.

16. The composition of claim 14, wherein the alkaline earth metal or alkali metal comprises Na.

17. The composition of 14, wherein the amount of alkaline earth metal or alkali metal in the composition is at least 250 ppm based on the weight of the composition.

18. The composition of claim 17, wherein the amount of alkaline earth metal or alkali metal ranges from 2000 ppm to 10 wt. %, based on the weight of the composition.

19. The composition of claim 1, wherein the molar ratio M:Al is at least 0.75:1.

20. The composition of claim 1, wherein the molar ratio M:Al ranges from 0.75:1 to 1.75:1.

21. The composition of claim 1, wherein the molar ratio M:Al ranges from 0.9:1 up to 3:1.

22. The composition of claim 1, wherein the composition is a solution at a molar ratio of M:Al ranging from 0.2:1 to 4:1.

23. The composition of claim 1, wherein said mono-ol ether is derived from a diol compound(s) having from 2 to 24 carbon atoms.

24. The composition of claim 23, wherein the diol compound comprises ethylene glycol, 1,3 propane diol, 1,4-butane diol, 1,5-pentane diol, 1,2-propane diol, or combinations thereof.

25. The composition of claim 1, wherein the mono-ol ether contains one or more ether groups.

26. The composition of claim 1, wherein the amount of the mono-ol ether solvent is sufficient to solubilize (i) and (ii).

27. The composition of claim 1, wherein the amount of mono-ol ether solvent ranges from 30 wt. % up to 90 wt. % based on the weight of the composition.

28. The composition of claim 1, wherein the mono-ether solvent comprises 2-methoxy ethanol, ethylene glycol butyl ether, 2-isopropxyethanol, ethylene glycol monophenyl ether, or combinations thereof.

29. The composition of claim 1, wherein the catalyst solution is prepared by combining (i) and (ii) and (iii) and heating the mixture at a temperature within a range of 80° C. to 150° C.

30. The composition of claim 1, comprising combining a lithium compound with an aluminum compound and said mono-ol ether solvent.

31. The composition of claim 30, comprising combining lithium hydroxide with a tridentate aluminum compound at a molar ratio of 1:1 to 5:1, with 2-methoxy ethanol or ethylene glycol butyl ether or both, and heating at a temperature of 80° C. to 150° C.

32. A polyester polymer composition comprising a catalyst system and a polyester polymer, said catalyst system obtained by combining
(i) M, wherein M is represented by an alkaline earth metal or alkali metal and
(ii) aluminum metal and
(iii) a mono-ol ether solvent,
wherein the molar ratio of M:Al ranges from 0.2:1 to 10:1.

33. The polyester polymer composition of claim 32, wherein the polyester polymer comprises a polyethylene terephthalate polymer.

34. The polyester polymer composition of claim 32, wherein M comprises lithium, sodium or potassium.

35. The polyester polymer composition of claim 34, wherein M comprises lithium.

36. The polyester polymer composition of claim 35, wherein the composition further comprises residues of phosphorus.

37. The polyester polymer composition of claim 36, wherein the polyester polymer has an It.V. of at least 0.70 dL/g obtained from a melt phase polymerization process.

38. A bottle preform comprising the polyester polymer composition of claim 37.

39. The polyester polymer composition of claim 37, wherein the polyester polymer has an L* of at least 70.

40. A beverage bottle comprising the polyester polymer composition of claim 39.

41. A process for making a polyester polymer composition comprising adding a solution to a melt phase polymerization process for making a polyester polymer, said solution comprising:
(i) M, wherein M is represented by an alkaline earth metal or alkali metal and
(ii) aluminum metal and
(iii) a mono-ol ether solvent,
wherein the molar ratio of M:Al ranges from 0.2:1 to 10:1.

42. The process of claim 41 wherein after the addition of said solution, a phosphorus compound is added to the melt phase polymerization process upon or after substantial completion of polymerization.

43. The process of claim 42, wherein the mole ratio of phosphorus P to M, representing the cumulative amount of (i) and (ii), is within a range of 0.5:1 to 2:1.

44. The process of claim 42, wherein the amount of phosphorus atoms ranges from 3 ppm to 50 ppm.

45. The process of claim 42, wherein the solution haze of the polyester polymer composition is 15 ntu or less.

46. The process of claim 42, wherein the relative reduction of haze by addition of phosphorus is 40% or more relative to the same polymer made without phosphorus.

47. The process of claim 41, wherein the polymer is made in the absence of adding a cobalt compound to the polymerization reactants.

48. The process of claim 41 wherein the polymer is made in the absence of a titanium catalyst.

49. The process of claim 41, wherein the polyester polymer is obtained by reacting:
(i) a carboxylic acid component comprising at least 80 mole % of the residues of terephthalic acid or derivates of terephthalic acid, and
(ii) a hydroxyl component comprising at least 80 mole % of the residues of ethylene glycol or propane diol,
based on 100 mole percent of carboxylic acid component and 100 mole percent of hydroxyl component in the polyester polymer.

50. The process of claim 41, wherein the solution is added an esterification zone.

51. The process of claim 41, wherein the solution is added at inception of or during polycondensing a polyester polymer.

52. The process of claim 41, wherein the solution is added to an oligomer mixture upon or after completion of esterification or to a polyester melt no later than when the It.V. of the melt reaches 0.3 dL/g.

53. A process for making a composition, comprising combining:
(i) M, wherein M is represented by an alkaline earth metal or alkali metal and
(ii) aluminum metal and
(iii) a mono-ol ether solvent,
wherein the molar ratio of M:Al ranges from 0.2:1 to 10:1, heating said composition, and passing a flow of a gas over the surface of said composition during at least a portion of said heating.

54. The process of claim 53, wherein the gas comprises an inert gas.

55. The process of claim 54, wherein the gas comprises at least 90 mole % nitrogen.

56. The process of claim 53, wherein the flow rate is at least 2 SCFH.

57. The process of claim 56, wherein M comprises Li.
